(19) United States
(12) Patent Application Publication
(10) Pub. No.: US 2004/0211248 A1
(43) Pub. Date: Oct. 28, 2004

(54) Internal combustion engine with device for determination of absolute rotary angle of crankshaft, and method for determination of absolute rotary angle of crankshaft

(76) Inventor: Uwe Kassner, Moeglingen (DE)

Correspondence Address: STRIKER, STRIKER & STENBY, 103 East Neck Road, Huntington, NY, 11743, US

(21) Appl. No.: 10/818,513

(22) Filed: Apr. 5, 2004

(30) Foreign Application Priority Data
Apr. 7, 2003 (DE) 103 15 816.2

(51) Int. Cl. G01M 15/00; F02P 1/00

(52) U.S. Cl. 73/117.3; 123/617

(57) ABSTRACT

In an internal combustion engine the device for determining an absolute rotary angle of a crankshaft, a component which is in operative connection with a camshaft has a plurality of markings, and the cost reduction is retained in that at least one sensor is arranged at the component and can determine the rotary direction of the camshaft.

### BACKGROUND OF THE INVENTION

The present invention relates to an internal combustion engine with a device for detecting the absolute rotary angle of a crankshaft, wherein a plurality of marks are applied on a component which is in operative connection with a camshaft.

For the control of internal combustion engines, the determination of the crankshaft position is a central task. Depending on the crankshaft angle, the injection of the fuel, the opening and closing of the inlet and outlet valves, and in an Otto-motor the ignition for each cylinder are controlled so that the individual work stages are run in an optimal manner.

Present solutions utilized incremental sensors on the crankshaft and camshaft. Sensor disks are conventionally provided with incremental marks which due to cooperation of the signals allow a determination of the motor position. The German patent document DE 0020165A1 discloses a method for determination of the rotary speed of the internal combustion engine, in which a transmitter disc is arranged on a rotatable component. The transmitter disc includes a plurality of teeth which are sensed by rotary sensors arranged on the periphery of the transmitter disc. Two rotary speed sensors are associated in the sensor wheel and are oriented relative to one another in an angular position depending on interference signals to be depressed and measure physical signals superimposed by the interference signal.

For a further improvement of the motor control, the crankshaft position has to be determined exactly during turning off of the motor. It is thereby possible to accelerate substantially a new start of the motor with positive action on comfort and exhaust gas conditions.

It is especially important to know the crankshaft position for the so-called start-stop operation with the use of the direct start in direct injection Otto-motors. The direct start is a start without use of an auxiliary device by injection into a cylinder, whose inlet and outlet valves are closed and subsequent ignition by an ignition spark. The produced moment releases a movement of the crankshaft which makes possible the combustion in further cylinders and thereby a start or run up of the motor. Exactly for the start-stop operation, or in other words an automatic turning off of the motor at the traffic light or the like, the fast and low noise start is advantageous. A recognition of the standing vehicle by a logic is conventional, which with the presence of further conditions, for example the uncoupling of a clutch, turns an automatic transmission to neutral position or the like by means of the available control of the motor, and with a predetermined driver reactions, such as for example the coupling of the clutch or applying gas with an automatic transmission, again automatically starts the motor. In these process it is important that a control during stopping of the motor is performed so that a predetermined crankshaft position is reached. Only from a predetermined angle interval, a successful direct stop of the motor is possible without an auxiliary drive.

The devices and methods which are known from the prior art can not perform these tasks. During turning off of the motor a swinging of the crankshaft takes place, or in other words a movement in both rotary directions. An incremental system with corresponding one sensor naturally does not recognize the rotary direction and therefore can not reliably determine the absolute position, or in other words the absolute rotary angle of the crankshaft or the camshaft. After the turning off, with a standing motor it is necessary to check whether the absolute position is located within a permissible angular interval which makes possible the direct start. If the crankshaft or the camshaft is not located within the interval required for a direct start, for example after turning of the motor by movement of the vehicle, the start is performed via the available auxiliary drive.

German patent document DE 199 006 41 A1 discloses a device and a method for rotary angle determination of the camshaft in a multi-cylinder internal combustion engine. For determination of the camshaft angle, a permanent magnet is arranged on the camshaft, and near it a magnetic field-sensitive measuring pickup is located, so that through its signal a control device provides a continuous, high resolution angular signal.

Disadvantages of an absolute angular signal in accordance with the prior art include the higher cost when compared to the sensors for an increment system in accordance with the prior art, and in addition corresponding structural requirements can not be satisfied in principle, for example an access to the cam shaft end is not possible. Also, a disadvantage in some cases is a required complex signal process in the sensor, as well as additional signal processing in the control.

### SUMMARY OF THE INVENTION

Accordingly, it is an object of the present invention to provide a combustion engine with a device for detecting an absolute rotary angle of a crankshaft, which avoids the disadvantages of the prior art.

In keeping with these objects and with others which will become apparent hereinafter, one feature of the present invention resides, briefly stated in an internal combustion engine, comprising an engine part with a crankshaft and a camshaft; and a device for determining an absolute rotary angle of a crankshaft, said device including a component being in operative connection with said camshaft and being provided with a plurality of markings, and at least one sensor which is arranged at said component and is operative for determining a rotary direction of said camshaft.

In accordance with an embodiment of the internal combustion engine of the present invention, it is proposed to arrange two sensors on the component so that from a comparison of the measuring values produced by the marking during rotation of the crankshaft, a conclusion is possible about the rotary direction of the crankshaft. Instead of measuring the rotary angle of the camshaft, here also the rotary angle of the crankshaft can be measured, and by additional means it can be determined in which region between 0 and 720°, that make a complete work stroke of a four stroke motor, the crankshaft is located at this point. This can be supplied for example by sensors of the valve control or the like.

The component that is inoperative connection with the camshaft is conventionally a transmitter disk which is directly connected with the camshaft. Depending on the type of the drive of the camshaft, also a drive means located between a crankshaft and a camshaft can be used, such as for example a toothed wheel, a belt disk, and the like.

The markings on the component can be arranged arbitrarily. However, it is advantageous when the markings are distributed substantially uniformly over the component, so that the rotary direction of the crankshaft can be determined from a phase displacement between the measuring values of the two sensors. When the markings are not distributed uniformly or equidistantly, the rotary direction can be determined based on the concept from which sensor an identifiable signal occurs, which performs the identification, for example from a correlation of the signal length, signal height or the like. With an equidistant distribution the signal ideally is rectangular. In reality the flanks can be not ideally steep, so that a signal which deviates from a rectangle can occur. Also, with the non-ideal signal a time displacement between both sensors can be determined with respect to the periodical signals. From the time displacement or phase displacement between both signals, indirectly the rotary direction of the camshaft or the crankshaft can be determined.

In accordance with a further embodiment of the present invention, the component has can have a further mark which is different from the markings, and the mark is associated with a predetermined crankshaft position. The further mark can be, for example, a cutout in a transmitter disk with a substantially greater length than the remaining cutouts or the like. This mark which is raised relative to the other markings appears only once over the periphery of the component and therefore makes possible a conclusion about the absolute position of this mark.

In accordance with a further embodiment of the present invention, it is proposed that the two sensors are arranged at the component with a relative angle relative to one another so that a phase displacement which depends on the rotary direction of the crankshaft causes the signals of the sensors.

In accordance with a further embodiment of the present invention, it is proposed that the sensors operate optically, inductively, or capacitatively. Preferably inductive or capacitative sensors are used.

In a further embodiment of the present invention, it is proposed that at least one sensor includes means which allow a determination of the rotary direction of the camshaft alone from measuring signals of the sensors. Typical embodiments for this construction are sensors with two or three measuring elements arranged near one another in one housing, which directly determine the rotary direction from the time sequence of the signal changes and can output this information additionally to the angular speed. For example, a wheel rotary speed sensor for ABS systems is usable with this design, in which a pulse-width modulated signal codes the rotary speed information, for example by a shorter pulse for a left running and a longer pulse for a right running.

The above mentioned problem is also solved by a method for determination of the absolute rotary angle of the crankshaft with use of an internal combustion engine, in which the rotary direction of the crankshaft is determined from a phase displacement between the measuring values of the two sensors.

In a further embodiment of the invention it is proposed that the absolute crankshaft angle is determined from a sign-marked increments starting from an initial value.

In a further embodiment of the method it is proposed that the sign-mark increment is determined from the phase displacement and the number of the markings.

In accordance with a further embodiment of the method it is proposed that the initial value is determined from the further mark. The increment is determined from the markings which are distributed over the component. The sign of the increment is determined from the rotary direction. The initial value is determined from the further mark. For this purpose it must be known, in which crankshaft condition the initial value is located. The determination of the camshaft condition is performed preferably with the turned-off internal combustion engine in a start-stop operation.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing an arrangement of sensors and a transmitter disc in accordance with the present invention;

FIG. 2 is a schematic view showing a signal course of the sensors over the time;

FIG. 2 is a view showing a first example of a pulse coding in accordance with the present invention; and

FIG. 4 is a view showing a second example of a pulse coding in accordance with the present invention.

### DESCRIPTION OF THE PREFERRED EMBODIMENTS

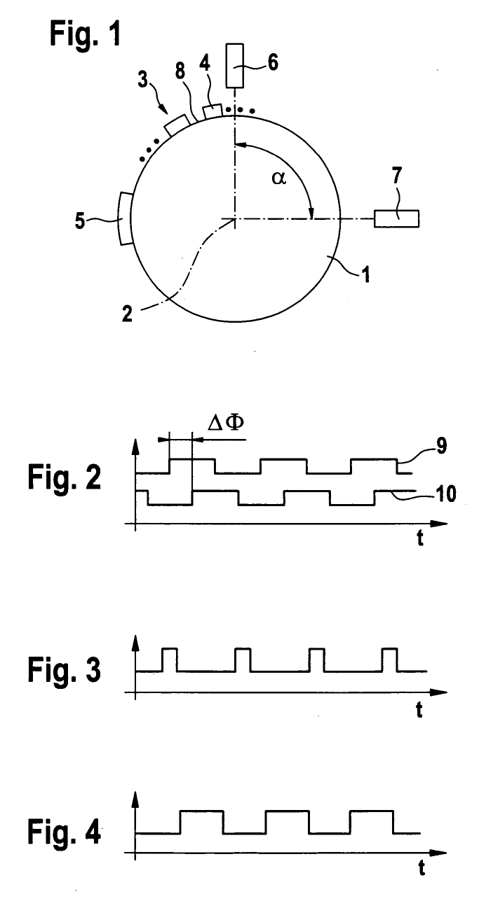

FIG. 1 schematically shows a transmitter disk 1 which is arranged for example directly on a crankshaft or camshaft, or is connected indirectly by transmission elements for rotation with the camshaft. The transmitter disk 1 rotates around an axis 2. Markings 3 are arranged on an outer periphery of the transmitter disk 1. The markings can be composed for example of teeth 4 which are arranged correspondingly equidistantly over the outer periphery of the transmitter disk 1. Tooth gaps 8 are provided between the teeth 4.

A further mark 5 marks a certain zero position of the camshaft. It can be formed for example as a double width of the tooth 4 or as a greater tooth distance between two teeth 4, or the like. A first sensor 6 and a second sensor 7 are arranged at the periphery of the transmitter disk 1. The sensors 6 and 7 are distributed in different angular regions over the transmitter disk 1. For example, the sensors can have an angle α relative to one another, as shown in FIG. 1, which for example is equal to substantially 900. However, any different angle is also possible.

During a rotation of the camshaft and thereby of the transmitter disk 1, the teeth 4 as well as the marking 5 pass the sensors 6 and 7. Thereby for example an electrical signal is released in the sensors 6 and 7. The sensors 6 and 7 can be inductive or capacitive sensors. Alternatively, the sensors 6 and 7 can operate optically. For example optical changes caused in them by the teeth 4 or the mark 5 can be measured.

FIG. 2 shows the single course of the sensors 6 and 7 over the time t. The alternating passage of the teeth 4 and tooth gaps 8 produces a corresponding rectangular signal both in the signal course 9 of the sensor 6 and in the signal course 10 of the sensor 7. The signals 9 and 10 are displaced relative to one another by a face displacement Δφ. From the magnitude of the face displacement Δφ the rotary direction of the camshaft can be derived. The rotary direction is obtained from the phase displacement Δφ as well as the arrangement of the sensors 6 and 7 over the outer periphery of the transmitter disk 1.

The conventional resolution of the angle amounts to 6°, and with a gap of two angle units, 58 tooth or pole pairs are applied on the transmitter disc. The sensors 6 and 7 are mounted so that the angle between them is greater than the gap in the transmitter disc 10. Thereby one of the two sensors always recognizes the movement of the crankshaft. The angle α is selected so that it does not form a direct multiple of the pitch of the transmitter disk 1, since then the signals of the sensors 6 and 7 would be cycle-identical without a phase displacement.

Alternatively, a sensor 6, 7 can be used which can itself recognize the rotary direction of the transmitter disk 1. Typical embodiments include a sensor with two or three measuring elements arranged near one another in one housing, which determine directly the rotary direction from the time sequence of the signal change, and can output this information additionally to angular speed. For example, a wheel rotary speed sensor for ABS systems is usable with this design, in which a pulse width modulated signal codes the rotary speed information, for example by a shorter pulse for a left running and a longer pulse for a right running. FIGS. 3 and 4 show these cases. FIG. 3 shows a shorter pulse, which identifies thereby a left running, and FIG. 4 shows a longer pulse which identifies a right running.

The signal processing is performed for example so that the signal of the first sensor is evaluated for the general function of the motor control as before. Additionally the rotary direction information for adding or subtracting an angle increment in a counter is used in the program of the control device. When the sensor 6 is located over the gap of the transmitter disk and no signal is produced, the signal of the second sensor 7 is evaluated exactly in the same manner.

Alternatively, one first sensor 6 can be utilized, which does not provide any rotary direction information. For this sensor variants are preferable, which perform an active measuring principle, for example with sensors provided with Hall elements. The sensors operating in accordance with these measuring principles can produce a useful signal also with very low rotary speed of the crankshaft.

For the second sensor 7, a sensor is used, which can recognize the rotary direction in correspondence with the preceding illustration of the transmitter disk. Only the angular position of the sensor 7 is important for the absolute angle determination. The signal of the sensor 7 with its rotary direction information is required in the crankshaft angle interval, in which a direction reverse during the motor running is performed. This region can be determined from tests of motors and considerations of the moments of the individual cylinders. The further sensors 7 is arranged so that the gap in the transmission disk 1 in this interval is not opposite to the second sensor 7.

After a motor start, both previously shown variants of the sensor arrangement after a half crankshaft resolution are capable to measure accurately the absolute angle and to determine correctly the direction changes. This fast detection uses the asymmetrical pitch of the camshaft signal. The system therefore is capable to determine the absolute position during turning off of the motor to the stoppage of the motor.

For start-stop operation, the absolute position must be determined in the moment of the next start. This is obtained by a further evaluation of the both crankshaft sensors during the motor stop, or in other words the control of the motor monitors the above mentioned logic of the sensor signals with the turned-off motor and adds or subtracts the corresponding angle increments to the determined angle. Each turning of the motor marked from outside is determined, and in a moment of the next start the absolute angle is known.

Both the control required for the above described process as well as the sensors are not operation-ready between the manual turning off and the start of the internal combustion engine. When the motor is manually turned off, the total system is no longer operation-ready. It is however retained operation-ready in the case, in which in the start-stop operation of the motor a preceding turning off of the motor is performed.

It will be understood that each of the elements described above, or two or more together, may also find a useful application in other types of constructions and methods differing from the types described above.

While the invention has been illustrated and described as embodied in internal combustion engine with device for detecting absolute rotary angle of crankshaft, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An internal combustion engine, comprising an engine part with a crankshaft and a camshaft; and a device for determining an absolute rotary angle of a crankshaft, said device including a component being in operative connection with said camshaft and being provided with a plurality of markings, and at least one sensor which is arranged at said component and is operative for determining a rotary direction of said camshaft.

2. An internal combustion engine as defined in claim 1, wherein two such sensors are arranged at said component so that from a comparison of measuring values caused by said markings during a rotation of said crankshaft, a conclusion above the rotary direction of the crankshaft can be made.

3. An internal combustion engine as defined in claim 2, wherein said markings are distributed substantially uniformly over said component and the rotary direction of the crankshaft is determinable from a phase displacement between the measuring values of said two sensors.

4. An internal combustion engine as defined in claim 1, wherein said component has a further mark which is different from said markings, and is associated with a predetermined crankshaft position.

5. An internal combustion engine as defined in claim 2, wherein said two sensors are arranged at said component with an angle relative to one another so that a phase displacement of signals of said sensors, dependent on the rotary direction of said camshaft, is provided.

6. An internal combustion engine as defined in claim 1, wherein said at least one sensor has means for determining the rotary direction of the camshaft from measuring signals of said at least one sensor.

7. A method of determining an absolute rotary angle of a crankshaft of an internal combustion engine having a crankshaft and a camshaft, comprising the steps of providing a component which is in operative connection with the camshaft and has a plurality of markings; and
determining a rotary direction of the camshaft by at least one sensor arranged at the component.

8. A method as defined in claim 7; and further comprising providing two such sensors; and determining the rotary direction of the crankshaft from a phase displacement between measuring values of the two sensors.

9. A method as defined in claim 7, wherein said determining includes determining an absolute crankshaft angle from a sign-marked increment starting from an initial value.

10. A method as defined in claim 9; and further comprising determining the sign-marked increment from the phase displacement and a number of the markings.

11. A method as defined in claim 9; and further comprising determining the initial value from a further mark.
